(19) United States
(12) Patent Application Publication
(10) Pub. No.: US 2017/0226771 A1
(43) Pub. Date: Aug. 10, 2017

(54) HANDLE-EQUIPPED LOCK

(71) Applicant: OVIKU OY, Vantaa (FI)

(72) Inventor: Tomi EK, Vantaa (FI)

(73) Assignee: OVIKU OY, Vantaa (FI)

(21) Appl. No.: 15/128,322

(22) PCT Filed: Apr. 10, 2014
(86) PCT No.: PCT/FI2014/050260

§ 371 Date: Sep. 22, 2016

(30) Foreign Application Priority Data
Apr. 10, 2013 (FI) 20135350
Jun. 25, 2013 (FI) 20135691

(51) Int. Cl. E05B 13/00; E05B 15/00

(52) U.S. Cl. CPC E05B 13/004; E05B 13/005; E05B 15/0033

(57) ABSTRACT

A handle-equipped lock. The lock comprises a latch bolt, a lock housing, and a release mechanism inside the lock housing. The handle includes handgrip, a spindle sleeve contiguous with the handgrip, and a polygonal shaped spindle, which has a part of its length inside the spindle sleeve and which is dimensioned to extend to an engagement with the lock's release mechanism. The shaped spindle, or a part thereof, is adapted to be manipulated inside the spindle sleeve between an unlocking position and a locking position. In the unlocking position, the shaped spindle extends to the lock's release mechanism and in the locking position it does not extend. The shaped spindle and the spindle sleeve are provided with locking means for securing the same relative to each other in said locking position, wherein manipulation of the shaped spindle is prevented. Alternatively, a continuous shaped spindle extends through the lock and the handle is capable of being manipulated relative to the shaped spindle between an unlocking position and a locking position.

The invention relates to a handle-equipped lock as presented in the preamble of the appended claim 1.

Interior doors are often provided with handle-operated latches that cannot be locked. This is because there is generally no need for locking interior doors. Occasionally, however, it would be preferable to have also the interior door temporarily locked.

It is an object of the invention to provide a handle-equipped lock by which this temporary locking need can be fulfilled without the lock as such being a key operated lock. The invention can also be used for a more secure locking protection in locks which have a non-serialized key.

This object is attained in the invention with a lock presented in the appended claim 1 or 2. The dependent claims present preferred embodiments of the invention.

Publication GB 2241282 discloses a handle-equipped lock, wherein one of the handles intended for opening the door can be removed, thereby immobilizing the handle left on the other side of the door. However, this does not resolve the problem addressed by the invention as there must be a capability of locking and unlocking the door from the same side.

Publication US 2005212306 discloses a handle-equipped lock, wherein a square spindle is adapted to be retracted into a handle for enabling the handle to be installed on doors of varying thicknesses. The retraction of a square spindle is conducted by means of a spring which engages the square spindle. This prior known solution is not intended for locking a door.

Publication FR 2 374 490 discloses a window lock handle, which is fitted with locking means capable of preventing children from using the handle for opening the window lock. The lock comprises a simple bar or dowel to be turned with the handle for opening and locking the window.

Three different exemplary embodiments of the invention will now be described more closely with reference to the accompanying drawings, in which

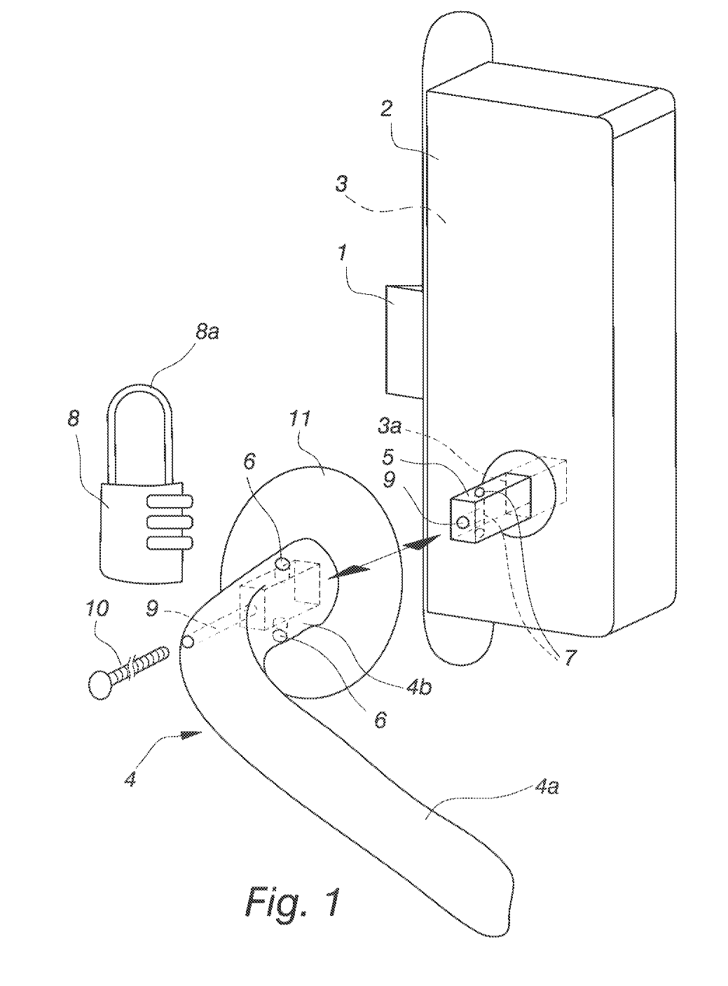

FIG. 1 shows, in a perspective view, a handle-equipped lock according to a first embodiment of the invention.

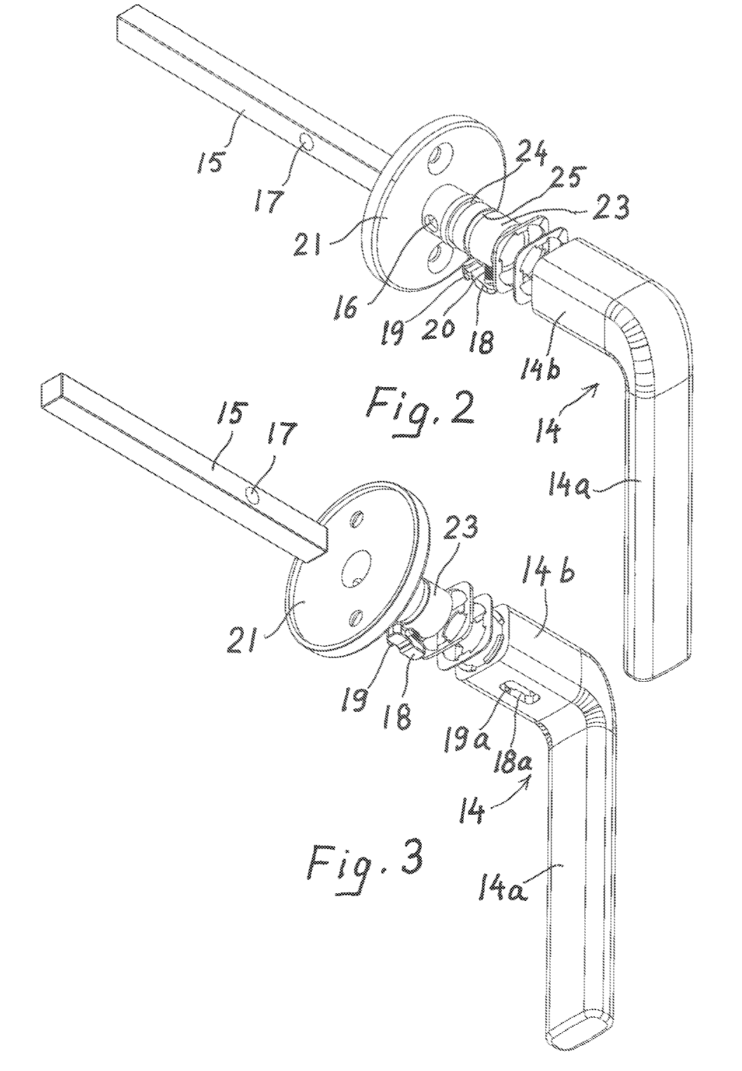

FIG. 2 shows, in a perspective view, a lock handle according to a second embodiment of the invention, and a shaped spindle by way of which the latch bolt can be operated by turning the handle.

FIG. 3 shows the same as FIG. 2 from a different perspective.

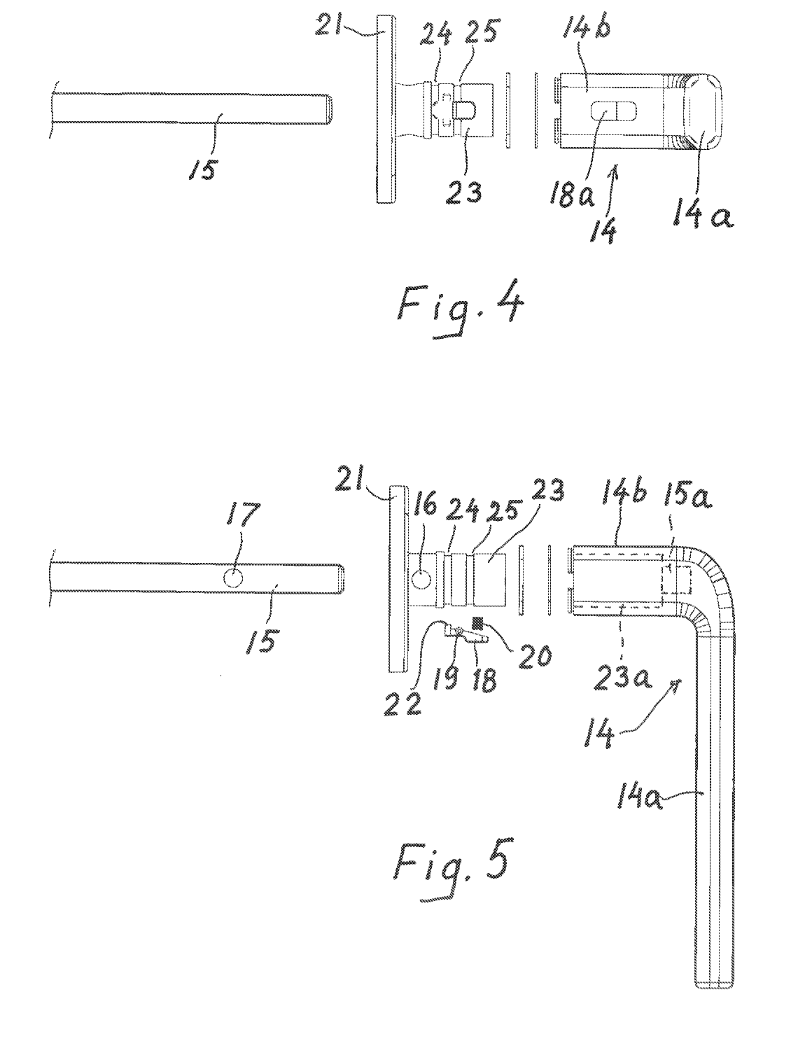

FIGS. 4 and 5 show the same as FIGS. 2 and 3 in side and bottom views, respectively.

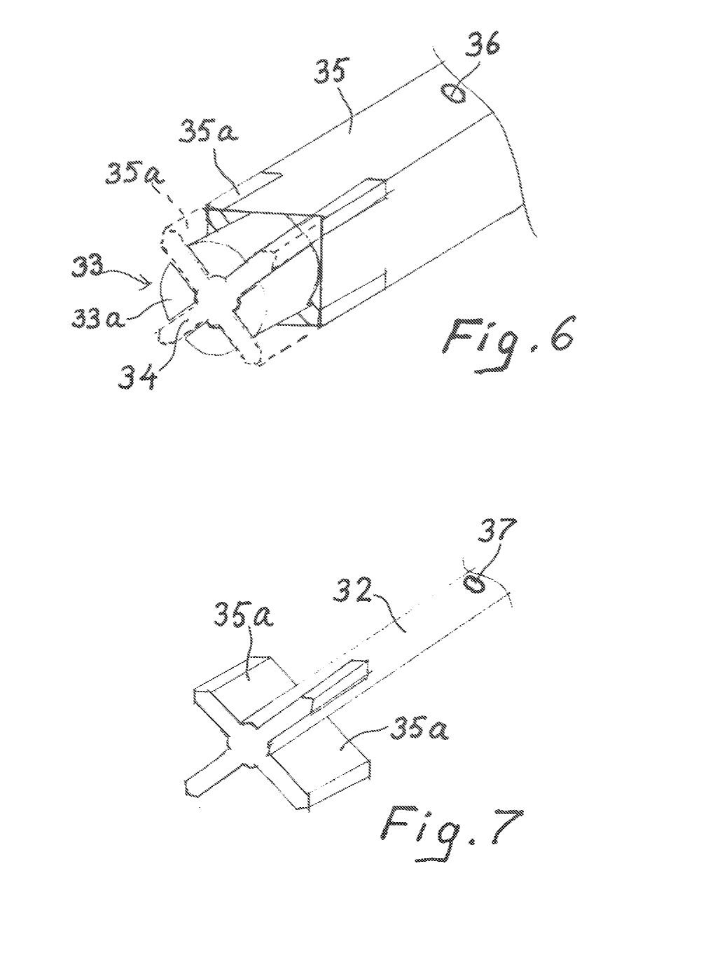

FIG. 6 shows a shaped spindle according to a third embodiment of the invention, which is adaptable to the lock of FIG. 1 as an alternative solution.

FIG. 7 shows a movable part of the shaped spindle of FIG. 6.

The lock according FIG. 1 includes a latch bolt 1 and a lock housing 2, inside which is a release mechanism 3 not described further in this context as it does not constitute an object of the invention. The release mechanism 3 varies in terms of features and functions according to various lock types and various manufacturers.

A handle 4 comprises a handgrip 4a and a spindle sleeve 4b contiguous with the handgrip. The handle 4 is in engagement with a polygonal shaped spindle 5, which is typically a square spindle. Over some of its length, the shaped spindle 5 is located inside the spindle sleeve 4b and dimensioned to extend to the engagement with the lock's release mechanism 3. The release mechanism 3 includes a part 3a with a complementary polygonal shaped receiving hole for the spindle 5. In typical internal door locks, the shaped spindle 5 extends continuously between the handles 4 present on either side of the door. In the embodiment of FIG. 1, the handles on either side of the door have separate shaped spindles 5. The shaped spindle 5 on a lockable side of the door and the space provided therefor in the spindle sleeve 4b are dimensioned in such a way that the shaped spindle 5 can be operated within the spindle socket 4b between a release position and a locking position. In the release position, the shaped spindle 5 extends to the lock release mechanism 3, but does not in the locking position, whereby the handle 4 is not able to retract the bolt 1 and the lock remains in a locked condition. The shaped spindle 5 and the spindle sleeve 4b are provided with clamping means 6, 7, 8 for the mutual clamping thereof in said locking position.

In the illustrated exemplary embodiment, the clamping means include a padlock 8, which can be for example a combination lock for easy communication of a digital code needed for unlocking. The clamping means also include holes 6 and 7, penetrating respectively through the spindle sleeve and the spindle and being capable in the locking position of being brought to coincide with each other and being dimensioned for allowing a shackle 8a of the padlock to pass through.

In the illustrated case, the operating elements for the shaped spindle 5 include a screw 10 in threaded engagement with a hole 9 at the spindle end, wherefor the spindle sleeve 4b features a hole 9 lengthwise of the spindle 5 for allowing a longitudinal movement of the screw 10. The hole 9 opens up at an outer surface of the handle 4, from which a head of the screw 10 is discernible for enabling manipulation of the shaped spindle 5 by means of the screw 10. Being pushed by the screw 10, the shaped spindle 5 can be shifted to an unlocking position, i.e. to an engagement with the release mechanism 3. The illustrated exemplary embodiment is just one feasible approach. Manipulation of the shaped spindle 5 can be implemented in several other ways, for example with the assistance of a spring or springs. The spindle 5 can also have a cross-section in the shape of a crescent moon.

For the handle 4 to retain its position, the spindle sleeve 4b has its end typically provided with a groove and a circlip, which is left behind a ferrule 11 to be mounted on the door. This is one way of setting the end of the spindle socket 4b in a rotation-allowing but axial movement preventing engagement with the ferrule 11 to be mounted on the door.

In the embodiment of FIGS. 2-5, a shaped spindle 15 is not split in the middle as in the embodiment of FIG. 1, but the spindle extends in a single piece between handles 4 present on the opposite sides of a door. A ferrule 21 is fastened with bolts passing through the door and the lock housing to a respective ferrule on an opposite side of the door. The solid heads of the bolts are located on the locking side. The figure illustrates a handle 14, which is located on a lockable side of the door and which is adapted to be shifted relative to the shaped spindle 15 between an unlocking position and a locking position. It is in the locking position that the handle 14 has been pulled a small distance away from the door, whereby the shaped spindle 15 has its end disengaged from a complementary shaped engagement recess 15a. Hence, the handle 14 and a handgrip 14a rotate freely around a support sleeve 23. The support sleeve 23 is fastened to the ferrule 21 or to the lock housing 2 and provided with two annular grooves 24 and 25 spaced at a small axial distance from each other. This distance matches a range of motion of the handle 14 between an unlocking position and a locking position. A spindle sleeve 14b features a cylindrical space 23a (FIG. 5) with, the support bushing 23 fitting therein.

The spindle sleeve 14b features an aperture 18a for receiving a rocker arm 18. The rocker arm has its trunnion pins 19 received in peripheral recesses 19a of the aperture 18a. The rocker arm 18, pivoting upon the trunnion pins 19 against the restoring force of a spring 20, is adapted to engage the annular groove 24 or 25 with its locking cam 22 (FIG. 5). By pressing the rocker arm 18 against the force of the spring 20, the locking cam 22 is enabled to disengage from the groove 24 or 25 and the handle 14 can be worked between an unlocking position and a locking position. Through holes 17 and 16 can be passed e.g. the shackle 8a of the combination lock 8, which prevents the handle 14 from being pushed back to the unlocking position even if the locking cam 22 were released from the groove 25 by pressing the rocker arm 18. In this locking position, the engagement recess 15a for the spindle sleeve 14b of the handle 14 does not reach far enough to make contact with the end of the spindle 15, nor can the lock be released from outside the door. If it is desired that the lock can nevertheless be released with the handle on an interior side of the door, the bushing 23 must be fitted in a rotatable manner on the ferrule 21. Regarding the rings to be set between the ferrule 21 and a butt of the spindle sleeve 14b, there will be a thicker plastic ring functioning as a slip ring, and a thinner steel spring ring as a retaining ring which engages behind a circular bead adjacent the groove 24 and inhibits a withdrawal of the handle 14 from its position.

In the embodiment of FIGS. 6 and 7, the body portion of a shaped spindle 35 is not moved back and forth, but a connecting shank 32 housed in the shaped spindle's body portion, along with its gripping elements 35a, is manipulated in axial direction relative to the shaped spindle's body portion. The gripping elements 35a are contiguous with the connecting shank 32, and the outer edges of the gripping elements 35a are always located on what are extensions for the corners of the shaped spindle's 35 body portion. By an axial displacement of the connecting shank 32, the gripping elements 35a are enabled to conduct a respective axial movement to an unlocking or locking position. In the unlocking position, the gripping elements 35a are in the vicinity of an engagement head 33, and the engagement head 33 has its recesses 34 receiving the gripping elements 35a which extend to the lock's release mechanism 3 (FIG. 1). In the locking position, the gripping elements 35a have become retracted into complementary shaped and sized cuts of the shaped spindle 35, away from the vicinity of the engagement head 33, whereby the round engagement head 33 rotates freely in the lock's release mechanism 3 and, hence, the lock and the door cannot be opened with the handgrip 4a.

In this exemplary embodiment as well, the locking means may include a combination lock 8, having its shackle 8a passable through holes 6, 36 and 37 when the connecting shank 32 is in the locking position, whereby the gripping elements 35a are in the position denoted with a solid line in FIG. 6. Alternatively, the combination lock can be constructed around the spindle sleeve 4b so as to secure a locking pin in the holes 6, 36, 37 and thereby to prevent a displacement of the connecting shank 32 away from the locking position. Thus, in the locking position, the holes 6, 36 of the spindle sleeve and the shaped spindle are in alignment with the hole 37 of the connecting shank. All these are dimensioned to receive a locking pin, which can be a padlock shackle or a cable lock wire. In case the spindle sleeve 4b includes a hole, which is lengthwise of the spindle 35 and which opens up at an outer surface of the handle 4a, from which emerges an outer end of the connecting shank 32 (such as the screw 10 in FIG. 1), the locking can also be provided at the outer end of the connecting shank 32 by preventing its insertion inwards. Manipulation of the connecting shank 32 can be arranged in several other ways, for example by making use of a spring or springs. The connecting shank can be circular or polygonal in cross-section and its clamping or retention in the locking position can be conducted in many ways, depending mostly on the need and application.

A common feature for all embodiments is that, by displacing the shaped spindle or a part thereof relative to the handle, or the handle relative to the shaped spindle, it is possible to disconnect the drive train between the handle and the lock mechanism, whereby the lock does not unlock by turning the handle.

1. A handle-equipped door lock, comprising a latch bolt (1), a lock housing (2), a release mechanism (3) inside the lock housing, and a handle (4) which includes a handgrip (4a), a spindle sleeve (4b) contiguous with the handgrip and a polygonal shaped spindle (5, 35), which has a part of its length housed inside the spindle sleeve (4b) and which is dimensioned to extend to an engagement with the lock's release mechanism (3), whereby the latch bolt (1) is retractable into the interior of the lock housing by pressing the handgrip (4a), the shaped spindle (5, 35) being adapted to be manipulated within the spindle sleeve (4b), characterized in that the shaped spindle (5), or a part (32, 35a) of the shaped spindle (35), is displaceable between an unlocking position and a locking position, that in the unlocking position the shaped spindle (5), or its part (32, 35a), extends to an engagement with the lock's release mechanism (3) and in the locking position it does not extend, and that the shaped spindle (5) or its part (32, 35a) and the spindle sleeve (4b) are provided with locking means (6, 7, 8, 36, 37) for locking the same relative to each other in said locking position, wherein manipulation of the shaped spindle (5) or its part (32, 35a) is prevented.

2. A handle-equipped door lock, comprising a latch bolt (1), a lock housing (2), a release mechanism (3) inside the lock housing, and a handle (14) which includes a handgrip (14a), a spindle sleeve (14b) contiguous with the handgrip, and a polygonal shaped spindle (15), which has a part of its length housed inside the spindle sleeve (14b) and which is dimensioned to extend to an engagement with the lock's release mechanism (3), whereby the latch bolt (1) is retractable into the interior of the lock housing by pressing the handgrip (14a), characterized in that the spindle sleeve (14b) is fitted in an axially displaceable manner around the shaped spindle (15), that between the shaped spindle and the spindle sleeve is fitted is support bushing (23) for the handle, which is fastened to a lock ferrule (21) or the lock housing (2), that the handle (4) is movable relative to the support bushing (23) and the shaped spindle (15) between an unlocking position and a locking position, that in the unlocking position the shaped spindle (15) extends to an engagement with a gripping formation (15a) of the spindle sleeve (14b) and in the locking position does not extend, and that the shaped spindle (15) and/or the support bushing (23) are provided with locking means (16, 17, 8) for securing the handle (14) in said locking position, wherein a displacement of the handle's (14) gripping, formation (15a) to an engagement with the shaped spindle (15) is prevented.

3. A lock according to claim 1, characterized in that the locking means include a padlock (8).

4. A lock according to claim 1, characterized in that the locking means include a combination lock (8).

5. A lock according to claim 1, characterized in that the locking means include holes (6, 7), which extend through the spindle sleeve (4b) and the spindle (5) and which are dimensioned for passing therethrough a shackle (8a) of the padlock or the combination lock.

6. A lock according to claim 2, characterized in that the locking to means include holes (16, 17), which extend through the support bushing (23) and the spindle (15) and which are dimensioned for passing therethrough a shackle (8a) of the padlock or the combination lock.

7. A lock according to claim 2, characterized in that the spindle sleeve (14b) is fitted with a rocker arm (18) whose locking cam (22) is engageable, by operating the handle (14), optionally with grooves (24, 25) included in the support bushing (23), said grooves being spaced from each other by a distance matching a range of motion for the handle (14) as the handle is actuated between the unlocking position and the locking position.
